(19) United States
(12) Patent Application Publication
(10) Pub. No.: US 2024/0354241 A1
(43) Pub. Date: Oct. 24, 2024

(54) METHOD OF TEST PLAN GENERATION FOR LIVE TESTING

(71) Applicant: TELEFONAKTIEBOLAGET LM ERICSSON (PUBL), Stockholm (SE)

(72) Inventors: Oussama Jebbar, Montreal (CA); Maria Toeroe, Montreal (CA); Ferhat Khendek, Montreal (CA)

(21) Appl. No.: 18/683,487

(22) PCT Filed: Aug. 15, 2022
(86) PCT No.: PCT/IB2022/057631

§ 371 Date: Feb. 13, 2024

Related U.S. Application Data
(60) Provisional application No. 63/234,386, filed on Aug. 18, 2021.

(51) Int. Cl. G06F 11/36

(52) U.S. Cl. CPC G06F 11/3688; G06F 11/3664; G06F 11/3684

(57) ABSTRACT

There is provided a method of test plan generation for live testing and corresponding system and non-transitory computer readable media. The method comprises generating test configurations under which a plurality of test suite items (TSIs) are to be run, merging call paths, in a plurality of groups, according to intersections of call paths on which each of the plurality of TSIs are to be applied and environment coverage associated with the TSIs. The method comprises selecting a test method for each configured instance in each call path associated with one group of call paths. The method comprises creating an initial UML Testing Profile (UTP) model by mapping the TSIs to UTP test cases, thereby generating test runs, and deleting any duplicate test runs. The method comprises ordering test runs and selecting a test runtime framework for each TSI for which the test plan is generated.

### PRIORITY STATEMENT UNDER 35 U.S.C. S.119 (E) & 37 C.F.R. S.1.78

This non-provisional patent application claims priority based upon the prior U.S. provisional patent application entitled “METHOD OF TEST PLAN GENERATION FOR LIVE TESTING”, application No. 63/234,386, filed Aug. 18, 2021, in the names of Jebbar et al.

### TECHNICAL FIELD

The present disclosure relates to the generation of test plans and live testing in production environment.

### BACKGROUND

Recently, testing in the production environment attracted both the industry and the academia as it is used for several purposes such as service composition, fault localization, evaluation of business objectives, etc. Such testing needs to be conducted without unacceptable disturbance to the production traffic. Testing a system in its production environment without causing any unacceptable disturbance is called live testing.

The main challenge of live testing is avoiding test interference. Test interference is an alteration, degradation, or loss of a system's property due to the coexistence of test activities and production traffic. In other words, the coexistence of the test activities and production traffic can lead to a violation of one of the system's functional or non-functional requirements. The countermeasures taken to alleviate the risk associated with test interferences are known as test isolation. Other challenges such as diversity of test cases and their runtime environments, short reaction times due to stringent non-functional requirements such as high availability, the number of test configurations under which test cases are to be run, etc., add to the complexity of conducting testing activities in modern production systems such as clouds and zero touch networks. Because of this increased complexity, handling manually testing activities such as test planning becomes more tedious and error prone.

The concept of test plan has more than one definition in the literature. In some work “test plan” is used to refer to a test suite. A broader definition of test plan is an artifact that documents a test scope, test configurations, and test cases used to validate a new version of a product. ISO29119-1 [ISO/IEC/IEEE 29119-1. Software and systems engineering—Software testing—Part 1: Concepts and definitions. First edition, 2013] defines a test plan as a detailed description of test objectives to be achieved as well as the means and schedule for achieving them, organized to coordinate testing activities for some test item or a set of test items. Furthermore, ISO29119-2 [ISO/IEC/IEEE 29119-2. Software and systems engineering—Software testing—Part 2: Test processes. First edition, 2013] defines the test planning process as the process used to develop a test plan. The test planning according to this standard consists of several steps among which, identification and analysis of risks, identification of risk mitigation approaches, designing test strategy, and determining the test schedule. A test execution plan is a set of actions that achieve the test objective, and that are generated by applying a set of rules (derived from the user provided input and some pre-set rule templates). The method proposed in the literature does not explicitly handle the creation of the test schedule, although it can be adapted to achieve that. However, the test execution plan can select the test actions and determine the test resources (tester, runtime environment, etc.) needed to execute them.

### SUMMARY

Test planning is the process of developing a test plan. Test management decisions such as the determination of test case schedule, test configurations selection, the resources needed for test execution, etc. are all made during test planning. Furthermore, planning for live testing requires making some extra decisions such as the selection of isolation countermeasures. None of the previously existing test plan generation methods address all the activities necessary to generate a test plan for live testing when the test traffic and the production traffic co-exist. Accordingly, the test plan generation method presented herein takes into consideration the risk of interference with the production traffic and applies mitigation strategies such as test isolation, reduction of the time needed for testing as well as unavoidable service outages. Considering all these elements in the context of cloud systems adds further complexity that needs to be considered.

The definitions used herein for test plan and test planning coincide to some extent with the definitions proposed in the ISO standard. In fact, the test plan as proposed herein includes the test objective (of the test session) as well as the means to achieve the test objective (the test cases and test configurations). Furthermore, the test plan generation approach that is proposed herein covers creating the test schedule as well as the identification of risks (applicability check of test methods) and the risk mitigation approaches as well as the design of a test strategy (test method selection).

An approach for the automated generation of test plans is therefore proposed. The generated test plan is specified using a Unified Modeling Language (UML) Testing Profile (UTP), and it is based on the architectural and modeling framework proposed in [O. Jebbar, F. Khendek, M. Toeroe. Architecture for the Automation of Live Testing of Cloud Systems. In the proceedings of the 20th IEEE International Conference on Software Quality, Reliability, and Security, IEEE QRS ‘2020].

One goal of the test plan generation method proposed herein is to maintain the disturbance within an acceptable range at execution. It is based on the fact that all test plans that execute the same set of test cases, each of which is mapped to a set of test configurations under which it should be run, have the same number of test runs, i.e. the same cost (time wise and disturbance wise) for running the test cases. Therefore, the only aspect by which one test plan outperforms another one is in the way the test plan handles the deployments of test configurations.

One goal of test plan generation is to design a test plan that enables its execution under the required test configurations while maintaining the disturbance level within an acceptable range.

Given a test suite and a set of test configurations against which each test suite item (TSI) is to be run, the number of the resulting test runs will always be the same for this combination regardless of how the test plan was designed.

The test plan generation has the following activities:
Generating the test configurations under which each TSI is to be run. This generation is based on the system configuration and the environment coverage criterion provided as input for each TSI.
Call path merging is an activity of the test plan generation that can be carried out while test configurations are being generated. It relies on the intersections of the call paths on which each TSI is to be applied, as well as the environment coverage associated with each TSI. Based on this, TSIs are identified that can be deployed at once.
A test method selection activity selects the test method that will be used for each configured instance (CI) in each call path associated with a group created in the call path merging.
Creation of an initial UTP model via mapping the TSIs to UTP and cleaning up any duplicate test runs.
A test runs ordering activity achieves two goals: 1) orders the test runs based on the precedence relationships between their associated TSIs; and, at the same time, 2) orders the test runs based on their associated test configurations to reduce disturbance.
Wrapping up the test plan generation by selecting the test runtime framework for each TSI that will be executed in the test session.

The generated test plan is then submitted to the test execution module to execute it in the production cloud system.

Test planning is a key task for the orchestration of test activities in production. Inappropriate planning of such an orchestration may induce some unnecessary outages or can even lead to the violation of some functional or non-functional requirements of the system. Designing test plans manually is complex, tedious and error prone. The method proposed herein automates the generation of test plans to be used to orchestrate the test execution in a cloud production system.

The proposed method uses UTP as modeling framework for test plans, and uses the test methods proposed in PCT/IB2021/057344, by the same authors, to safely orchestrate test cases in the production system. In the selection of test methods and ordering of test runs the methods ensures that the service outage imposed on the production traffic is kept at an acceptable level and that the test activities take the least amount of time possible to perform all the necessary test runs.

There is provided a method of test plan generation for live testing. The method comprises generating test configurations under which a plurality of test suite items (TSIs) are to be run. The method comprises merging call paths in a plurality of groups of call paths, according to intersections of the call paths on which each of the plurality of TSIs are to be applied, and environment coverage associated with each of the plurality of TSIs. The method comprises selecting a test method to be used for each of a plurality of configured instances (CIs) in each of the call paths associated with one of the plurality of groups of call paths. The method comprises creating an initial Unified Modeling Language (UML) Testing Profile (UTP) model by mapping the TSIs to UTP test cases, thereby generating test runs, and by deleting any duplicate test runs. The method comprises ordering test runs based on precedence relationships between associated TSIs and based on associated test configurations. The method comprises selecting a test runtime framework for each TSI to be executed in a test session, for which the test plan is generated.

There is provided a system, apparatus (hardware (HW)) or node for test plan generation for live testing. The system, apparatus (HW) or node comprises processing circuits and a memory, the memory containing instructions executable by the processing circuits whereby the system, apparatus (HW) or node is operative to execute any of the steps described herein. The system, apparatus (HW) or node is operative to generate test configurations under which a plurality of test suite items (TSIs) are to be run. The system, apparatus (HW) or node is operative to merge call paths in a plurality of groups of call paths, according to intersections of the call paths on which each of the plurality of TSIs are to be applied, and environment coverage associated with each of the plurality of TSIs. The system, apparatus (HW) or node is operative to select a test method to be used for each of a plurality of configured instances (CIs) in each of the call paths associated with one of the plurality of groups of call paths. The system, apparatus (HW) or node is operative to create an initial Unified Modeling Language (UML) Testing Profile (UTP) model by mapping the TSIs to UTP test cases, thereby generating test runs, and deleting any duplicate test runs. The system, apparatus (HW) or node is operative to order test runs based on precedence relationships between associated TSIs and based on associated test configurations. The system, apparatus (HW) or node is operative to select a test runtime framework for each TSI, to be executed in a test session, for which the test plan is generated.

There is provided a non-transitory computer readable media having stored thereon instructions for test plan generation for live testing, the instructions comprising any of the steps described herein. The instructions comprise generating test configurations under which a plurality of test suite items (TSIs) are to be run. The instructions comprise merging call paths in a plurality of groups of call paths, according to intersections of the call paths on which each of the plurality of TSIs are to be applied, and environment coverage associated with each of the plurality of TSIs. The instructions comprise selecting a test method to be used for each of a plurality of configured instances (CIs) in each of the call paths associated with one of the plurality of groups of call paths. The instructions comprise creating an initial Unified Modeling Language (UML) Testing Profile (UTP) model by mapping the TSIs to UTP test cases, thereby generating test runs, and deleting any duplicate test runs. The instructions comprise ordering test runs based on precedence relationships between associated TSIs and based on associated test configurations. The instructions comprise selecting a test runtime framework for each TSI, to be executed in a test session, for which the test plan is generated.

The method, system, apparatus or node and non-transitory computer readable media provided herein present improvements to the way test plan generation for live testing operate.

### BRIEF DESCRIPTION OF THE DRAWINGS

FIG. 1 is a block diagram of a modeling of a TestCase with UTP.

FIG. 2 is a block diagram of a modeling of a single step test method.

FIG. 3 is a block diagram of a modeling of a rolling paths test method.

FIG. 4 is a block diagram of an overall test plan generation approach.

FIG. 5 is a schematic illustration of a system configuration according to an illustrative example.

FIG. 6 is a call graph of ConfiguredInstances associated with the configuration of FIG. 5.

FIG. 7 (parts I and II), is a schematic illustration of an output UTP model.

FIG. 8 is a flowchart of a method of test plan generation for live testing.

FIG. 9 is a schematic illustration of a virtualization environment in which the different method and system or apparatus described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

To reduce the cost of their services, cloud service providers satisfy the requirements of their tenants using configurable software which can be configured differently to provide different features with different characteristics. Configurations can be tenant configurations, application configurations, or deployment configurations. Applying a set of configurations to a configurable software yields a configured instance (CI). The workload handled by a single CI is called a service instance (SI). The requirements of a tenant are satisfied using a service which consists of one SI or multiple SIs composing it.

Configurations play various roles in the behavior and operation of configurable software. Application configurations are used to expose/refine features of the configurable software which are parameterized differently for different tenants using tenant configurations. When instantiated, a CI yields a set of components, each on a separate node, which are actively providing the actual SI. The number of such components, their locations (physical or virtual nodes that may change over time), their interactions with components of other CIs, the policies that govern the number of such components etc. are aspects that are set using deployment configurations. Furthermore, the scalability of the CIs is also set at deployment configuration level. Parameters that are used to configure scalability include the cool down period and scaling step. The cool down is the minimum period between two consecutive scaling actions. The scaling step sets the number of components instantiated (respectively terminated) in each scaling out (respectively scaling in) action.

The number of components of each CI, their locations, and their binding information change over time due to recoveries from failures as well as scaling actions. Such information is captured in the runtime configuration state of a system. The set of runtime configuration states in which a system can be depends on the system's configuration. When the system is in a given runtime configuration state, each component is located on a specific node, in a specific network, sharing that node with a set of components from other CIs. The location information (node and network) and collocation information define the environment under which the component is actually serving. Therefore, a runtime configuration state is identified by the set of environments under which the components of the CIs are serving when the system is in that runtime configuration state. Furthermore, it is also possible to identify runtime configuration states by the environments under which the SIs that compose each service are provided. For each service, such a combination of environments is called the path through which the service is provided. Note that for services that are composed of a single SI, the concept of path coincides with the concept of environment as there are no combinations of environments to consider at this level. As a result, the concept of path, as defined herein, is not to be confused with path in white box testing which may refer to control flow path or data flow path. To validate the compliance of the services to the requirements, cloud service providers use test cases as needed. These test cases may involve one or more CIs depending on the requirements the test case covers.

### Modeling a Test Plan Using UML Testing Profile

The modeling of a test plan using UTP is done through the mapping between the concepts proposed in [O. Jebbar, F. Khendek, M. Toeroe. Architecture for the Automation of Live Testing of Cloud Systems. In the proceedings of the 20th IEEE International Conference on Software Quality, Reliability, and Security, IEEE QRS ‘2020], included herein by reference in its entirety, and the ones defined in UTP as shown in Table I. This mapping models a test plan as a TestExecutionSchedule that runs UTP TestCases. UTP TestCases consist of one or more test cases provided by the vendor or the developer along with a test configuration. UTP TestProcedures are used to model invocations of vendor provided test cases and may be modeled using UML concepts. UTP also offers the possibility of specifying TestProcedures using other languages as OpaqueBehavior (a concept inherited from UML). UTP TestCases also include a setup ProcedureInvocation which is used for preparation and deployment of the test configuration, and a teardown ProcedureInvocation which is used to tear down the test configuration. Test configurations in UTP include modeling the configuration of the test component as well as the configuration of the test item (system or component under test). The modeling framework used herein is agnostic to the pattern with which these configurations are modeled (as a class or a constraint) although it is recommended to model these configurations as constraints.

TABLE I
MAPPING THE ARTIFACTS IN THE ABSTRACT
ARCHITECTURE TO UTP CONCEPTS

| Abstract Architecture | |
|---|---|
| concepts | UTP concepts |
| Test suite item in the test plan | ProcedureInvocation in the main phase |
| | of a TestCase |
| Test suite item runs | TestCase |
| Test plan | TestExecutionSchedule |
| Test preparation including the | TestCase setup procedure invocation |
| setting up of isolation | |
| countermeasure | |
| Test completion including the | TestCase teardown procedure invocation |
| cleanup of isolation | |
| countermeasure | |
| Test goal | TestRequirement or TestObjective |

### Test Methods

In a previous work from the same authors [O. Jebbar, F. Khendek, M. Toeroe. Methods for Live Testing of Cloud Services. In the proceedings of the 32nd IFIP International Conference on Testing Software and Systems. ICTSS, 2020], a set of test methods was proposed that can be used to perform live testing of cloud services. These test methods are applicable in an environment that supports 1) snapshotting and cloning of components; and, 2) service relocation as means of state transfer between components and are described next.

The single step is a test method which can be used to test services for which there is no potential risk of interferences. Using the single step method, it is possible to set up some paths to be iteratively tested, execute the test case on the paths that were set up, remove these paths, and then proceed to the next iteration until all the paths have been tested. The small flip test method is a test method that can be used when there is a potential risk of interferences and the number of components, say K, needed to provide the SI is less than half the number of nodes on which the CI is deployed. Using a small flip, one proceeds in two iterations 1) in the first iteration the paths that are set up are the ones that involve K nodes not currently used by the SI; and, 2) the second iteration tests the paths that involve the rest of the nodes on which the CI is deployed. Note that between the first and the second iterations the SI needs to be relocated to be provided through the paths that were tested in the first iteration. When the available resources do not allow to use a small flip, the use of the rolling paths test method was proposed. In a rolling paths test method, one path at a time is iteratively set up, tested, and removed, before moving forward to test the next path (following the same steps) in the next iteration until there is no path to test. In this case, going from one iteration to another often involves a service relocation. Finally, when the service relocation induces intolerable disturbance, the big flip test method is proposed which consists of creating a new CI, the test CI, which is tested using the single step test method, then the SI is relocated to the tested CI and the old CI is removed.

Test cases need to be run under paths (test configurations) that are representative of the runtime configuration states in which the system can be. These runtime configuration states are described by the environments of the components of the system when the system is in that runtime configuration state. A set of coverage criteria have been proposed that enable the tester to exercise a set of environments that is representative of the environments in which a component can be in the various runtime configuration states. Two important concepts to define such coverage criteria are the boundary environment and location, while a mixture is defined as an assignment of a number of occurrences over the set of boundary environments of a given CI. The sum of these assigned numbers of occurrences is called the mixture width. A set of coverage criteria for mixture of width one (also known as paths), as well as coverage criteria for mixtures of arbitrary width has also been previously described by the authors.

### Modeling Test Methods Using UTP

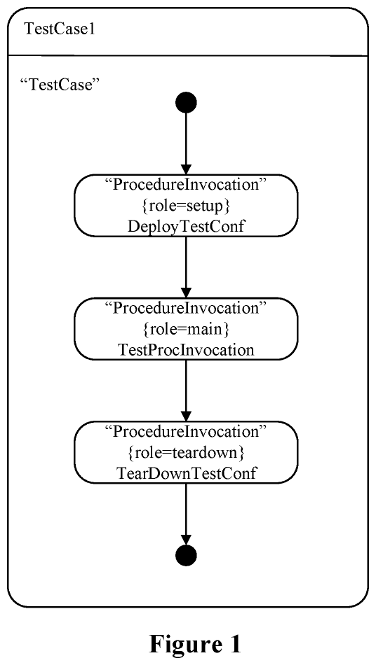

The test method used for isolation is an important element not yet mapped to UTP. The test methods are patterns in which the test runs can be arranged to isolate the test traffic from the production traffic. Each UTP TestCase combines a set of one or more test suite item (TSI) runs that are run under the same TestConfiguration, i.e. the same path. FIG. 1 shows a TestCase with three invoked behaviors: 1) a behavior to deploy the test configuration, i.e. setup the path to be exercised, 2) a behavior that invokes the TSIs to execute against this path, and 3) a behavior to tear down the test configuration. UTP offers roles that can be assigned to such invocations, namely, setup, main, or teardown.

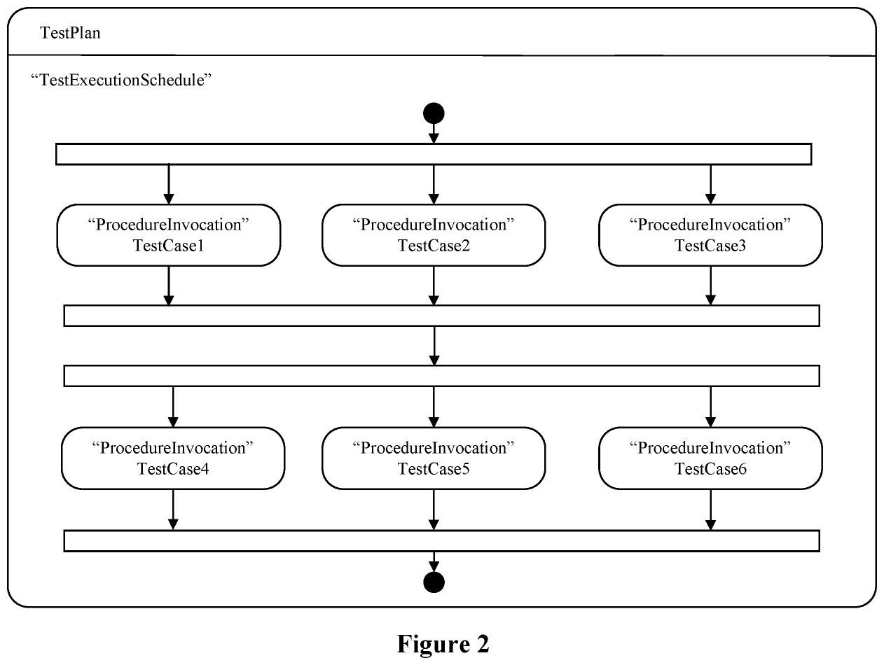

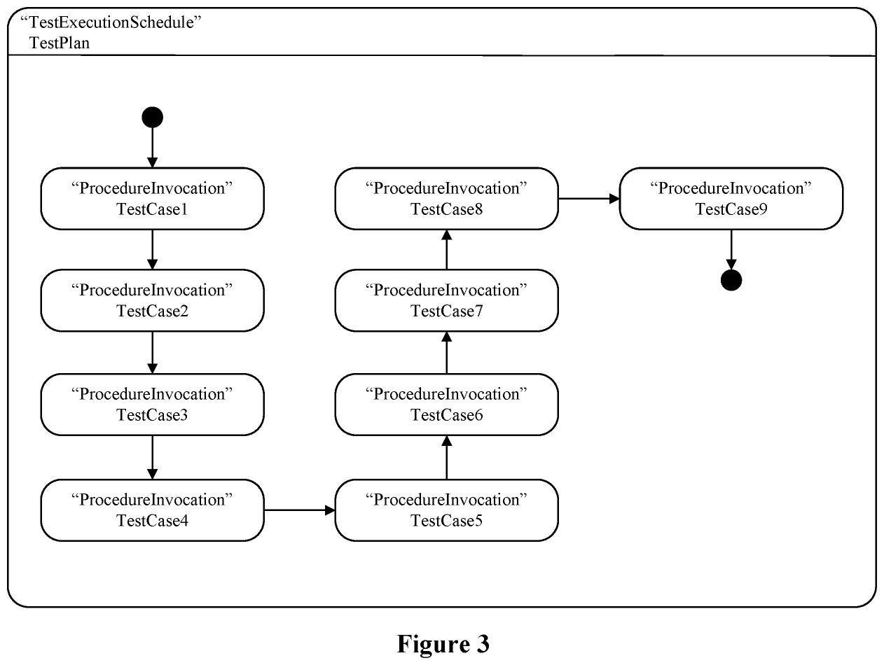

Since the test methods iteratively execute the TSIs against one or more paths (in each iteration), until all the required paths are exercised; these test methods can be modeled as CombinedFragments of UTP TestCases. The specification of a CombinedFragment, per test method, goes as follows:
Single step: each iteration of a single step test method is modeled as a ParallelFragment. UTP TestCases corresponding to the paths of an iteration are invoked in the fragment of that iteration. Fragments of the iterations are then put sequentially. FIG. 2 illustrates such pattern for a situation where a set of TSIs is to be executed under six paths and the maximum number of paths that can be deployed at once is three. Therefore, the model ends up with a first parallel fragment that executes the TSIs under the first three paths, and then deploys the next three paths to execute the TSIs against.
Rolling paths: the rolling paths is modeled as a sequence of UTP TestCases. FIG. 3 illustrates a rolling paths test method modeled in UTP. In the rolling paths, only a single path can be setup at a time, therefore, the UTP TestCases are invoked sequentially. Each invoked UTP TestCase executes a set of TSIs against a test configuration (i.e. a path).
Small flip: the small flip is modeled as two consecutive single steps (FIG. 2), targeting two disjoint sets of paths, separated by a service relocation ProcedureInvocation.
Big flip: the big flip is modeled as a single step (FIG. 2) preceded by a ProcedureInvocation that sets up the test CI; and, followed by a ProcedureInvocation that relocates the service and removes the old CI.

### Test Plan Generation

The goal of test plan generation is to design a test plan that enables the execution of TSIs under the required test configurations while maintaining the disturbance level within an acceptable range. Moreover, the test plan design may strive to reduce the disturbance induced and the time taken by testing activities to make such disturbance less noticeable or more tolerable.

Given a test suite and a set of test configurations against which each TSI is to be run, the number of the resulting test runs will always be the same for this combination regardless of how the test plan was designed. The cost considered herein consists of the time taken and disturbance induced by the execution of a test plan and it can be broken down into: 1) a cost endured by running the TSIs; and 2) a cost endured by the setup and teardown of test configurations (setting up and removal of paths). It is assumed that the former will be the same per TSI for all test plans involving a given test suite and a given set of test configurations. Thus, improvements can only be achieved by playing with the latter, i.e. the cost of setting up and tearing down test configurations. As a result, many activities that are proposed in this approach focus mainly on reducing the number of times a test configuration is deployed, and its deployment time.

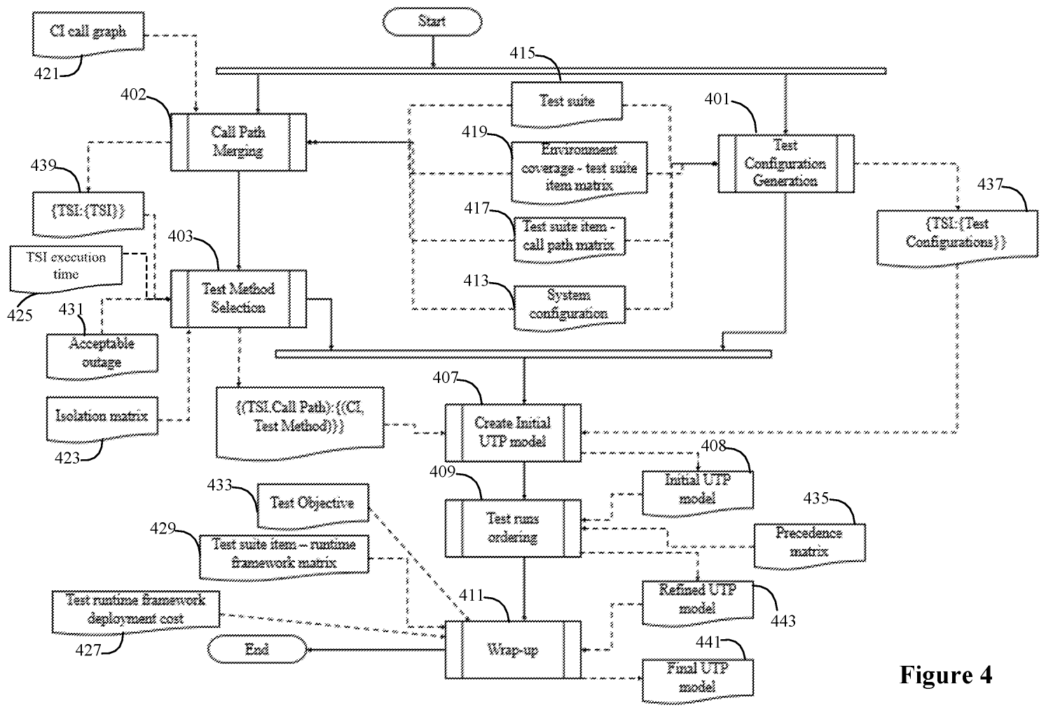

The test plan generation method is shown in FIG. 4. It starts by generating the test configurations 401 under which each TSI is to be run. This generation is based mainly on the system configuration and the environment coverage criterion that the test plan designer provided as input for each TSI. Call path merging 402 is an activity of the test plan generation that can be carried out while test configurations are being generated. This activity is the first step in reducing the number of times test configurations are deployed. It mainly relies on the intersections of the call paths on which each TSI is to be applied, as well as the environment coverage associated with each TSI. Based on such information one can identify TSIs that will be associated with test configurations that can be deployed at once. The goal of call path merging is to put such TSIs into the same group. Therefore, there exists a test configuration, associated with a TSI of a group, that will have to be deployed for all the TSIs of the group to have their runs executed. After the call paths merging activity, the test method selection activity 403 selects the test method that will be used for each CI in each call path associated with a group from the previous activity. After completing the test method selection 403 and the test configuration generation 401, an initial UTP model is created 407 using the mapping in Table I, and by cleaning up any duplicate test runs which may result from previous activities (mainly call paths merging). The initial UTP model 408 is then given to the Test runs ordering activity 409 which achieves two goals: 1) orders the test runs based on the precedence relationships between their associated TSIs; and, at the same time, 2) orders the test runs based on their associated test configurations to reduce disturbance. After the test runs ordering activity, the test plan generation is wrapped up 411 by selecting the test runtime framework for each TSI that will be executed in the test session.

### Input Artifacts

The input artifacts of the method are as follow:
a) System configuration 413: composed of the configurations of all the CIs that compose the system.
b) Test suite 415: a set of test cases and test design techniques that will be used to achieve the test objective. Each element of the test suite is a TSI.
c) TSI application matrix 417: maps every TSI to a call path in the CIs call graph. The vertices of such a path represent the CIs that are targeted by the TSI.
d) Environment coverage-TSI matrix 419: maps every TSI to the environment coverage that its runs should achieve.
e) CIs call graph 421: a directed graph that captures functional dependencies between the CIs. Each vertex in this graph represents a CI in the system. An edge going from vertex V1 to vertex V2 means that the CI represented by V1 calls the CI represented by V2 in a realization of one of the services provided by the system. Each edge has a weight that represents the tolerance time of the CI represented by the source of the edge to the unavailability of the CI represented by the target of the edge. Such representation of the system can be extracted automatically. Moreover, the weights of the edges of such a graph (i.e. the tolerance time) is usually part of the configuration and indicates the outage unnoticeable for the dependent CI.
f) Isolation cost matrix 423: associates with every CI in the system the time it takes: 1) to snapshot one of its components, 2) to clone one of its components from an existing snapshot, and 3) to relocate from one of its components to another the portion of the SIs a component provides. Such information can be provided either by the CI vendor or measured when the CI is first acquired by the service provider.
g) TSI execution time 425: associates with each TSI an estimate of the time one of its runs may take. This information is usually provided by the test developer. In a context that leverages automation, such information can be collected from previous runs of the TSI or set by a default value.
h) Test runtime framework deployment cost 427: associates with every test runtime framework the deployment alternatives and the time it takes to deploy it using each possible alternative. Such information is usually available at test case (or TSI) development time.
i) TSI test runtime framework matrix 429: associates with every TSI the runtime framework that is needed to execute the TSI. Such information is usually available at test case (or TSI) development time.
j) Acceptable outage 431: associates with every SI the duration for which it can be unavailable during the testing. A SI is said to be unavailable if it was inaccessible to a dependent SI for longer than the tolerance time of this dependent SI or if the availability manager reports it as unavailable (if the SI has no dependent). Acceptable outage is the time spent by the SI in an outage that is noticeable, while the tolerance time is the time for which the disturbance of the SI is tolerable.
k) Test objective 433: the objective that needs to be achieved by the test session for which the test plan is to be generated.
l) TSIs precedence matrix 435: is a matrix that maps each TSI in the test suite, to TSIs in the test suite that have to be executed before it. Such information is usually available at TSI development time.

### Test Configuration Generation

The test configuration generation activity 401 generates test configurations 437 under which the TSIs will be run. In a test configuration, each CI along the call path is assigned a mixture, such an assignment specifies the path under which the TSI run is to be conducted. The test configuration generation takes as input the test suite 415 (b), the environment coverage-TSI matrix 419 (d), the system configuration 413 (a), and the TSI-call path matrix 417 (c). The generation of test configuration is done with respect to the coverage criteria provided in (d). The generation of test configurations that takes into consideration the environment coverage has three main steps: First the boundary environments are identified from the configuration for the required coverage criterion. Then, the mixtures are created based on the set of boundary environments and the mixtures width. Finally, the set of test configurations that satisfy required criterion is created according to the following:
all boundary environment mixtures paths coverage: as the cartesian product of the sets of mixtures of the CI along the call path;
pairwise boundary environment mixtures: as the covering array of strength two created by considering each CI as a factor and each mixture of a CI is a level of the factor associated with that CI; or
all boundary environments mixtures: as the covering array of strength one created by considering each CI as a factor and each mixture of a CI is a level of the factor associated with that CI.

### Call Paths Merging

The call paths merging 402 helps reduce the cost of testing by playing with the first factor that contributes to the cost which is the number of times test configurations are deployed. Because more than one TSIs may have runs under the same test configuration, deploying such test configurations only once and invoking the TSIs is indeed a way to reduce the number of test configurations deployments. This merging takes as input the test suite 415 (b), the TSI call path matrix 417 (c), the environment coverage-TSI matrix 419 (d), and the CIs call graph 421 (e). The output of the call paths merging activity is a set of groups of TSIs 439, the runs of TSIs of each group under a given test configuration are invoked within the same UTP TestCase in the final UTP TestExecutionSchedule model 441. A call path is a path (as defined in graph theory) in the CIs call graph 421 (e). Path A is a sub-path of path B if: 1) all vertices of A are also vertices of B; and 2) all edges of A are also edges of B. Accordingly, B can be considered as a super-path to A. A super path is the reversal of a sub-path: if all edges and vertices of A are also edges and vertices of B, then B is a super-path of A and A is a sub-path of B. In other words, if A is a sub-path of B, then B is a super-path of A. In S set of paths, a max-path is a path which is a super-path to all paths in S. In the set of paths S, max-path of S is the path which is super-path to all paths in S.

The call paths merging follows two rules. A path A can be merged with S set of paths only if:
A is a super-path to the max-path of S, and the width of the mixtures in which A is to be covered is greater than or equal to the maximum width in which the max-path of S is to be covered; or
A is a sub-path of the max-path of S, and there exists at least one mixture width in which the max-path of S is to be covered that is greater than or equal to the width of the mixtures in which A is to be covered.

Applying these two rules may result in two types of merges:
Full merge: which is a merge that happens when the sub-path has a weaker environment coverage criterion than the super-path. It is called full merge because the runs of the sub-path are covered by the runs of the super-path.
Partial merge: which is a merge that happens when the sub-path has stronger environment coverage criterion than the super-path. It is called partial merge because the runs of the super-path will not be enough to cover all the runs of the sub-path. As a result, the runs of the sub-path may be split over several super-paths, and some runs may need to be covered in addition, and will be executed together.

The goal of the call paths merging activity is to perform as many full merges and partial merges as possible, thus reducing the number of times some test configurations will be setup to execute the TSIs runs.

Algorithm 1: Call Path Merging

| | |
|---|---|
| 1 | CI_CG: CI call graph; |
| 2 | TS: Test Suite; |
| 3 | EC_TSI: Environment coverage - Test suite item matrix; |
| 4 | TSI_CP: Test suite item - call path matrix; |
| 5 | TSI_G: Test suite item groupings = { }; |
| 6 | while TS not Empty do |
| 7 | cTSI = TS.first( ); |
| 8 | if TSI_G not Empty then |
| 9 | for t in TSI_G do |
| 10 | if TSI_CP.get(cTSI).isSubPath(TSI_CP.get(t)) then |
| 11 | if EC_TSI.get(cTSI).isWeakerThan(EC_TSI.get(t)) and |
| | EC_TSI.get(cTSI).isOfLessWidth(11 EC_TSI.get(t)) then |
| 12 | TSI_G.get(t).add(cTSI); |
| 13 | TS.remove(cTSI); |
| 14 | break; |
| 15 | if TSI_CP.get(t).isSubPath(TSI_CP.get(cTSI)) then |
| 16 | if EC_TSI.get(t).isWeakerThan(EC_TSI.get(cTSI)) and |
| | EC_TSI.get(t).isOfLessWidth(18 EC_TSI.get(cTSI)) then |
| 17 | tmp = TSI_G.get(t); |
| 18 | tmp.add(cTSI); |
| 19 | TSI_G.put(cTS,tmp); |
| 20 | TSI_G.remove(t); |
| 21 | TS.remove(cTSI); |
| 22 | break; |
| 23 | end |
| 24 | if TS.contains(cTSI) then |
| 25 | isBeingMerged = false; |
| 26 | for t in TSI_G do |
| 27 | if TSI_CP.get(cTSI).isSubPath(TSI_CP.get(t)) then |
| 28 | if (not EC_TSI.get(cTSI).isWeakerThan(EC_TSI.get(t))) and |
| | EC_TSI.get(cTSI).isOfLessWidth(EC_TSI.get(t)) then |
| 29 | TSI_G.get(t).add(cTSI); |
| 30 | if not isBeingMerged then |
| 31 | isBeingMerged = true; |
| 32 | if TSI_CP.get(t).isSubPath(TSI_CP.get(cTSI)) then |
| 33 | if (not EC_TSI.get(t).isWeakerThan(EC_TSI.get(cTSI))) and |
| | EC_TSI.get(t).isOfLessWidth(EC_TSI.get(cTSI)) then |
| 34 | tmp = TSI_G.get(t); |
| 35 | tmp.add(cTSI); |
| 36 | TSI_G.put(cTS,tmp); |
| 37 | TS.remove(cTSI); |
| 38 | break; |
| 39 | end |
| 40 | if isBeingMerged and TS.contains(cTSI) then |
| 41 | TSI_G.put(cTSI,{cTSI}); |
| 42 | TS.remove(cTSI); |
| 43 | if TS.contains(cTSI) then |
| 44 | TSI_G.put(cTSI,{TSI}); |
| 45 | TS.remove(cTSI); |
| 46 | else |
| 47 | TSI_G.put(cTSI,{cTSI}); |
| 48 | TS.remove(cTSI); |
| 49 | end |

Algorithm 1: Call Path Merging (alternative version)

| | |
|---|---|
| 1 | CI_CG: (e), TS: Test Suite, EC_TSI: (d), TSI_CP: (c); |
| 2 | TSI_G: output = { }; |
| 3 | while TS not Empty do |
| 4 | cTSI = TS.rst( ); |
| 5 | if TSI_G not Empty then |
| 6 | for t in TSI_G do |
| 7 | if TSI_CP.get(cTSI).length == 1 then |
| 8 | if TSI_CP.get(cTSI).isSubPath(TSI_CP.get(t)) then |
| 9 | if EC_TSI.get(cTSI).isOfLessWidth(EC_TSI.get(t)) then |
| 10 | TSI_G.get(t).add(cTSI); TS.remove(cTSI); break; |
| | endif; |
| | endif; |
| | endif; |
| 11 | if TSI_CP.get(cTSI).isSubPath(TSI_CP.get(t)) then |
| 12 | if EC_TSI.get(cTSI).isWeakerThan(EC_TSI.get(t)) and |
| | EC_TSI.get(cTSI).isOfLessWidth(EC_TSI.get(t)) then |
| 13 | TSI_G.get(t).add(cTSI); |
| 14 | TS.remove(cTSI);break; |
| | endif |
| | endif |
| 15 | if TSI_CP.get(t).isSubPath(TSI_CP.get(cTSI)) then |
| 16 | if EC_TSI.get(t).isWeakerThan(EC_TSI.get(cTSI)) and |
| | EC_TSI.get(t).isOfLessWidth(EC_TSI.get(cTSI)) then |
| 17 | tmp = TSI_G.get(t); |
| 18 | tmp.add(cTSI); |
| 19 | TSI_G.put(cTS,tmp); |
| 20 | TSI_G.remove(t); |
| 21 | ADJUSTGROUPINGFULL(TSI_CP,EC_TSI,cTSI,TSI_G); |
| 22 | ADJUSTGROUPINGPARITAL(TSI_CP,EC_TSI,cTSI,TSI_G); |
| 23 | TS.remove(cTSI);break; |
| | endif; |
| | endif; |
| | endfor; |
| 24 | if TS.contains(cTSI) then |
| 25 | isBeingMerged = false; |
| 26 | for t in TSI_G do |
| 27 | if TSI_CP.get(cTSI).isSubPath(TSI_CP.get(t)) then |
| 28 | if (not EC_TSI.get(cTSI).isWeakerThan(EC_TSI.get(t))) and |
| | EC_TSI.get(cTSI).isOfLessWidth(EC_TSI.get(t)) then |
| 29 | TSI_G.get(t).add(cTSI); |
| 30 | if not isBeingMerged then |
| 31 | isBeingMerged = true; |
| | endif; |
| | endif; |
| | endif; |
| 32 | if TSI_CP.get(t).isSubPath(TSI_CP.get(cTSI)) then |
| 33 | if (not EC_TSI.get(t).isWeakerThan(EC_TSI.get(cTSI))) and |
| | EC_TSI.get(t).isOfLessWidth( EC_TSI.get(cTSI) ) then |
| 34 | tmp = TSI_G.get(t); |
| 35 | tmp.add(cTSI); |
| 36 | TSI_G.put(cTSI,tmp); |
| 37 | ADJUSTGROUPINGPARITAL(TSI_CP,EC_TSI,cTSI,TSI_G); |
| 38 | TS.remove(cTSI);break; |
| | endif; |
| | endif; |
| | endfor; |
| 39 | if isBeingMerged and TS.contains(cTSI) then |
| 40 | TSI_G.put(cTSI,{cTSI}); |
| 41 | TS.remove(cTSI); |
| | endif; |
| | endif; |
| 42 | if TS.contains(cTSI) then |
| 43 | TSI_G.put(cTSI,{cTSI}); |
| 44 | TS.remove(cTSI); |
| | endif; |
| 45 | else |
| 46 | TSI_G.put(cTSI,{cTSI}); |
| 47 | TS.remove(cTSI); |

```
      endif;
      endwhile;
procedure ADJUSTGROUPINGPARITAL(TSI_CP,EC_TSI,tsi,grouping)
  for nT in grouping do
    if TSI_CP.get(nT).isSubPath(TSI_CP.get(tsi)) then
      if not EC_TSI.get(nT).isWeakerThan(EC_TSI.get(tsi)) and
        EC_TSI.get(nT).isOfLessWidth(EC_TSI.get(tsi)) then
          grouping.get(tsi).addAll(grouping.get(nT));
      endif;
    endif;
  endfor;
procedure ADJUSTGROUPINGFULL(TSI_CP,EC_TSI,tsi,grouping)
  for nT in grouping do
    if TSI_CP.get(nT).isSubPath(TSI_CP.get(tsi)) then
      if EC_TSI.get(nT).isWeakerThan(EC_TSI.get(tsi)) and
        EC_TSI.get(nT).isOfLessWidth(EC_TSI.get(tsi)) then
          grouping.get(tsi).addAll(grouping.get(nT));
          grouping.remove(nT);
      endif;
    endif;
  endfor;
```

Algorithm 1 (A1) and Algorithm 1 alternative version (A1a) achieve the goals of the call paths merging activity, i.e. it applies as many full and partial merges as possible. From the algorithm one can identify several possibilities of the merging. Lines 10-23 of A1 or 7-23 of A1a show the possible scenarios of the full merge. The full merge can either be a full merge while maintaining the same max-path (lines 10-14 of A1 or 7-14 of A1a); or, a full merge in which the new TSI sets a new max-path for the group (lines 15-22 of A1 or 15-23 of A1a). Similarly, partial merges are done in various forms (lines 24-42 of A1 or 24-41 of A1a). The first scenario of a partial merge (line 24-31 of A1 or A1a) consists of distributing the runs of a TSI over several groups with max-paths that are super-paths to the call path of the TSI. The algorithm accounts for the case where such groups are not enough to cover all the runs of the TSI, thus the addition of another group (Line 41 of A1 or line 40 of A1a) to cover the remaining runs. In the second scenario of the partial merge (lines 32-39 of A1 or lines 32-38 of A1a), the max-path of the group to which the TSI is added is set by the newly added TSI. Therefore, this implies that all the runs of the new TSI are covered in this new group, but runs of the TSIs of the old group (the group before the addition of the new TSI) may not be all covered. Therefore, the algorithm keeps the old group as well to account for the runs that will not be covered by the group after the partial merge.

### Test Method Applicability and Selection

After grouping the test runs in the previous activity, sets of test runs that are grouped together are obtained. For each group of TSIs, the test method selection activity 403 selects the test methods that will be used. Since the test methods apply at the CI level, for each group of TSIs a test method is assigned for each CI in the max-path of that group of TSIs. The test method selection activity takes as input the groups of TSIs from the call paths merging and their associated paths, the system configuration 413 (a), the call graph of the CIs 421 (e), the isolation cost matrix 423 (f), the TSI execution time 425 (g), and the acceptable outage 431 (j). The selection of the test methods takes into consideration the availability of resources, the cost of isolation, the dependencies between CIs, and the amount of tolerable disturbance for each SI.

### Applicability Check of the Test Methods

A test method is said to be applicable to a given CI if it can be used for the isolation for this CI without causing any unacceptable outage. As a result, more than one test method may be applicable to a CI. Furthermore, a test method may be used even though it causes outage if this outage is acceptable. The applicability of the different test methods is determined as follows:
The single step test method is applicable for CIs that do not present any potential risk of interferences.
The rolling paths test method is applicable to a CI if the time it takes to snapshot a component of that CI is less than the tolerance time of all the SIs that depend on the SIs provided by this CI and the service relocation time is also less than the tolerance time of all the dependents.

$${\sum }_{env ∈ S} min ( N , \vert Nodes ( env ) \vert ) \leq \vert Nodes \vert - K - ⌈ \frac{\sum TestConfSetupTime + \sum TestExecutionTime}{coolDownPeriod} ⌉ \times scalingStep \qquad ( 1 )$$

The small flip is applicable whenever the rolling paths is applicable and the configuration allows it. In other words, the small flip is applicable to a CI if there exists S, for which Equation (1) holds. In Equation (1) env is a boundary environment, S is a set of boundary environments of the CI, N is the width of the mixture of the environment coverage criteria, Nodes(env) is the set of nodes that can host boundary environment env, K is the number of components needed by the CI at the time of the testing, and Nodes is the set of all nodes on which the CI is deployed. Note that K, the number of components needed at the time of the testing, may not be known at the time of the design of the test plan. It can be estimated based on the operational profile of the CI, or its worst-case value can be used.
If resources permit, the big flip can always be used. However, it is said to be applicable when the sum of the snapshot time, clone time, and the service relocation time is less than the acceptable outage. It is also preferred (in comparison with other methods) when the snapshot time or the service relocation time is more than the tolerance time of at least one dependent.

### Test Method Selection

The test method selection 403 is an important activity of the test plan generation because the decisions made during this activity impact the disturbance induced by the test plan execution. On the one hand, the test method selection impacts the number of test runs that can be executed simultaneously which impacts the time it takes to execute the test plan. On the other hand, it impacts the number of service relocations for each CI which impacts the level of disruption induced by the test plan execution. Therefore, the test methods can be selected in different ways to favor one factor over the other (execution time vs induced disruption).

In order to keep the disruption to the minimum, a test method can be selected for a given CI as follows:
If only one test method is applicable (based on the applicability check), select that test method.
If more than one test method is applicable, the precedence of test methods is single step, big flip, small flip, and last is the rolling paths.
Conflicts (e.g. due to resource needs) between two CIs are solved by setting the preferred test method for the CI with the bigger number of mixtures.

Algorithm 2: Test method selection

| | |
|---|---|
| 1 | TSI_G: Test suite items groupings; |
| 2 | Is_M: Isolation matrix; |
| 3 | A_O: Acceptable outage; |
| 4 | SysConf: System configuration; |
| 5 | CI_TM: Test method assignment; |
| 6 | foreach g in TSI_G do |
| 7 | Available_Resources = getAvailableResources(SysConf); |
| 8 | CI_TM.put(g.path,{ }); |
| 9 | for ci in g.path do |
| 10 | if getAplicableTM(Is_M,A_O,ci,SysConf).size( )==1 then |
| 11 | CI_TM.get(g.path).add((ci,getAplicableTM(Is_M,A_O,ci,SysConf).first( ))); |
| 12 | updateAvailableResources(CI_TM,Available_Resource); |
| 13 | end |
| 14 | g.path.sortByMixtureSize( ); |
| 15 | for ci in g.path do |
| 16 | if getAplicableTM(Is_M,A_O,ci,SysConf).size( )>1 and |
| | getAplicableTM(Is_M,A_O,ci,SysConf).size( ).contains(21 SingleStep) then |
| 17 | CI_TM.get(g.path).add((ci,SingeStep); |
| 18 | continue; |
| 19 | if getAplicableTM(Is_M,A_O,ci,SysConf).size( )>1 and |
| | getAplicableTM(Is_M,A_O,ci,SysConf).size( ).contains(BigFlip) then |
| 20 | CI_TM.get(g.path).add((ci,BigFlip); |
| 21 | updateAvailableResources(CI_TM,Available_Resource); |
| 22 | continue; |
| 23 | if getAplicableTM(Is_M,A_O,ci,SysConf).size( )>1 and |
| | getAplicableTM(Is_M,A_O,ci,SysConf).size( ).contains(SmallFlip) then |
| 24 | CI_TM.get(g.path).add((ci,SmallFlip); |
| 25 | updateAvailableResources(CI_TM,Available_Resource); |
| 26 | continue; |
| 27 | CI_TM.get(g.path).add((ci, RollingPaths); |
| 28 | updateAvailableResources(CI_TM,Available_Resource); |
| 29 | end |
| 30 | end |

Algorithm 2 enables the test method selection according to these rules. For each TSI group it initializes the test method assignment to the empty set (Line 8). Then it assigns a test method to each CI to which only one test method is applicable (lines 9-13). It then sorts the remaining CIs in a decreasing order of their mixture size (i.e. number of mixtures) (Line 14). It iterates through this sorted set of CIs and from the applicable test methods of each CI it assigns the most preferred one (lines 16-17, 19-20, 23-24, 27) and updates the set of available resources as it is used in subsequent iterations to select the test methods for the remaining CIs. The getApplicableTM( . . . ) function performs the applicability check as described in subsection D-1 to obtain the set of test methods that are applicable to a CI.

### Ordering of Test Runs

The ordering of test runs 409 has two goals: 1) ensuring that TSIs are invoked only when their preconditions are met, and 2) reducing the disturbance by reducing the impact of service relocations. Each test run is a combination of a TSI and a test configuration under which it will be invoked. The first goal of the test runs ordering is achieved by ordering the test runs based on the TSIs they invoke. The second goal is achieved by ordering the test configurations in a way that the more critical a CI is, the least service relocations it experiences. The ordering of test runs takes as input a test plan with test runs in arbitrary order and the test suite precedence matrix 435 (l). This process performs the ordering using the following operators on the test plan:
1. Ordering test runs by changing the order of invocation of TSIs within the same UTP TestCase.
2. Ordering test runs by changing the order of UTP TestCases to order test runs based on the test configurations they involve.
3. Ordering test runs by changing the UTP TestCase within which the TSI is invoked.

The first step of ordering test runs activity, described below, helps to achieve the first goal. After this step is completed, a TSI—the following TSI—will be invoked under a given test configuration only after all TSIs—the leading TSIs—that should precede this TSI (as per the precedence matrix) have been invoked under that same configuration. Therefore, this step uses only the first and third operators and proceeds according to the following rules:
If the subset of UTP TestCases in which the leading TSI is invoked includes the subset of UTP TestCases in which its following TSI is invoked, then order the invocations of the TSIs within the same UTP TestCase of the subset of UTP TestCases in which the following TSI is invoked in a way that the following TSI is always invoked after the leading TSI.
If the subset of UTP TestCases in which the following TSI is invoked is a union of a subset of UTP TestCases in which the leading TSI is invoked and a subset of UTP TestCases in which the leading TSI is not invoked; then for the first subset of the union order the invocations of the TSIs within the same UTP TestCase in a way that the following TSI is invoked after the leading TSI, and follow up this subset with the second subset of the union in which the leading TSI is not invoked.
If none of the above rules apply, the third operator is used to move invocations of the following TSI to the first UTP TestCase in which it can be invoked (as per the test configuration of that UTP TestCase) while maintaining the precedence constraint. Moving such invocation may lead to the violation of Equation 1 in case any of the CIs in the max-path is to be tested using small flip. When such violation occurs, the test method of such CI will change from small flip to rolling paths.

To achieve the second goal of the ordering, the test runs need to be ordered based on the test configurations they involve, to reduce the disturbance induced by service relocations. The solution proposed herein is based on the following assumption: the more similar consecutive test configurations are, the less disruption the services endure. To assess similarities between test configurations, they are represented as assignments of mixtures to nodes along a call path. Therefore, the similarity between two test configurations is the number of nodes along a call path to which different mixtures are assigned in the two test configurations. The ordering of UTP TestCases that takes into account such similarities goes along the following line:
For each call path, start from a random UTP TestCase as the current UTP TestCase.
The next UTP TestCase should be the one most similar to the current UTP TestCase, i.e. the UTP TestCase that involves a test configuration that changes the least number of mixtures from the test configuration of the current UTP TestCase. If more than one UTP TestCases change the same number of mixtures of the test configuration of the current UTP TestCase, the TestCase that changes the less critical CIs is chosen, i.e. disturbing less critical CIs is preferred compared to disturbing more critical CIs.

Algorithm 3: Test runs ordering

| | |
|---|---|
| 1 | UTP_M: Initial UTP Model; |
| 2 | P_M: Precedence Matrix; |
| 3 | toBeMaintained = { }; |
| 4 | foreach c in P_M do |
| 5 | if UTP_M.TestCases.select(t \|t.invokes(c.preceding)).includesAll( |

UTP_M.TestCases.select(t

| | |
|---|---|
| | \|t.invokes(c.following))) then |
| 6 | for tc in UTP_M.TestCases.select(t \|t.invokes(c.following)) do |
| 7 | placeAfter(tc,c.following,c.preceding); |
| 8 | end |
| 9 | readjust(UTP_M,toBeMaintained); |
| 10 | toBeMaintained.add(c); |
| 11 | continue; |
| 12 | if UTP_M.TestCases.select(t \|t.invokes(c.following)).includesAll( |

UTP_M.TestCases.select(t

| | |
|---|---|
| | \|t.invokes(c.preceding))) then |
| 13 | for tc in UTP_M.TestCases.select(t \|t.invokes(c.preceding)) do |
| 14 | placeAfter(tc,c.following,c.preceding); |
| 15 | for ftc in UTP_M.TestCases.select(t \|t.invokes(c.following) and not |
| | t.invokes(c.preceding)) do |
| 16 | placeAfter(UTP_M,ftc,tc); |
| 17 | end |
| 18 | end |
| 19 | readjust(UTP_M,toBeMaintained); |
| 20 | toBeMaintained.add(c); |
| 21 | continue; |
| 22 | if UTP_M.TestCases.select(t \|t.invokes(c.following)).excludesAll( |

UTP_M.TestCases.select(t

| | |
|---|---|
| | \|t.invokes(c.preceding))) then |
| 23 | for tc in UTP_M.TestCases.select(t \|t.invokes(c.preceding)) do |
| 24 | for ftc in UTP_M.TestCases.select(t \|t.invokes(c.following)) do |
| 25 | placeAfter(UTP_M,ftc,tc); |
| 26 | end |
| 27 | end |
| 28 | readjust(UTP_M,toBeMaintained); |
| 29 | toBeMaintained.add(c); |
| 30 | continue; |
| 31 | end |
| 32 | tcs = UTP_M.TestCases; |
| 33 | foreach tc in tcs do |
| 34 | toSort = UTP_M.TestCases.select(t \|t.invokedTCs.forall(itc, tc.invokes(itc))); |
| 35 | currentTc = tc; |
| 36 | while toSort not Empty do |
| 37 | next = MaxSimilar(currentTc.conf,toSort); |
| 38 | placeAfter(UTP_M,currentTc,next); |
| 39 | toSort.remove(currentTc); |
| 40 | tcs.remove(currentTc); |
| 41 | currentTc = next; |
| 42 | end |
| 43 | end |

Algorithm 3 can be used to order test runs according to the rules mentioned above. It first achieves the first goal of the ordering of test runs by taking into consideration the precedence constraints (lines 4-31). Then it achieves the second goal of ordering of test runs by taking into consideration the test configurations that the test runs involve (lines 33-43).

To achieve the first goal of test runs ordering, the first and third operators mentioned previously are used. Lines 5-10 address situations in which the first operator is used to maintain precedence constraint by ordering TSI invocations within the same UTP TestCase. Lines 22-29 address situations in which the third operator is used in Line 25 to maintain the precedence constraints by ordering UTP TestCases in the UTP model. Lines 12-20 use both operators, first operator in Line 14, and third operator in Line 16 in order to maintain the precedence constraints. Every time a precedence constraint is handled, it is added to a set of constraints, toBeMaintained, as readjustments with respect to these constraints are needed every time test runs are moved around to satisfy a new constraint.

To achieve the second goal of test runs ordering, i.e. reducing the disturbance, Algorithm 3 sorts UTP TestCases that invoke the same set of TSIs based on the test configurations they involve. To do so, for each UTP TestCase, tc, in the UTP model it starts first by finding the UTP TestCases that invoke the same set of TSIs as tc (Line 34). It places tc as the first UTP TestCase of that group, then places after tc the UTP TestCase that involves the configuration most similar to tc's configuration (lines 36-41). Every time a UTP TestCase is sorted it is removed from the set of UTP TestCases to be considered, this process keeps going until there are no more UTP TestCases to sort.

### Wrapup

The wrapup activity 411 helps completing the specification of the TestExecutionSchedule. It takes as input the test objective 433 (k), test runtime framework deployment cost 427 (h), TSI-test runtime framework matrix 429 (i), and the refined UTP model 443 obtained from the test runs ordering activity. This activity starts first by adding the TestObjective to the UTP model, i.e. by creating the TestObjective model element and filling in its description attribute with the test objective given as input. Then it proceeds to choose the most suitable runtime framework deployment. This is done first by identifying the runtime framework of the TSI from 429 (i), then checking the deployment options of this runtime framework in 427 (h) (whether the runtime framework can be deployed using a configuration manager, or using a VM image, or a container). Then the least disturbing option is chosen, the order of precedence between the deployment options (based on their increasing disturbance) are container deployment, then VM deployment, then the deployment using a configuration manager when no other option is available.

### Example

A prototype was implemented for testing the approach for test plan generation. The implementation was done using the Epsilon family of languages. Each one of the activities outlined in FIG. 4 is implemented as an Epsilon module. The test configuration generation, call path merging, test method selection, and the creation of initial UTP models are implemented using the Epsilon Object Language (EOL). The ordering of test runs is implemented using Epsilon Pattern Language (EPL). The prototype will be demonstrated through an illustrative example.

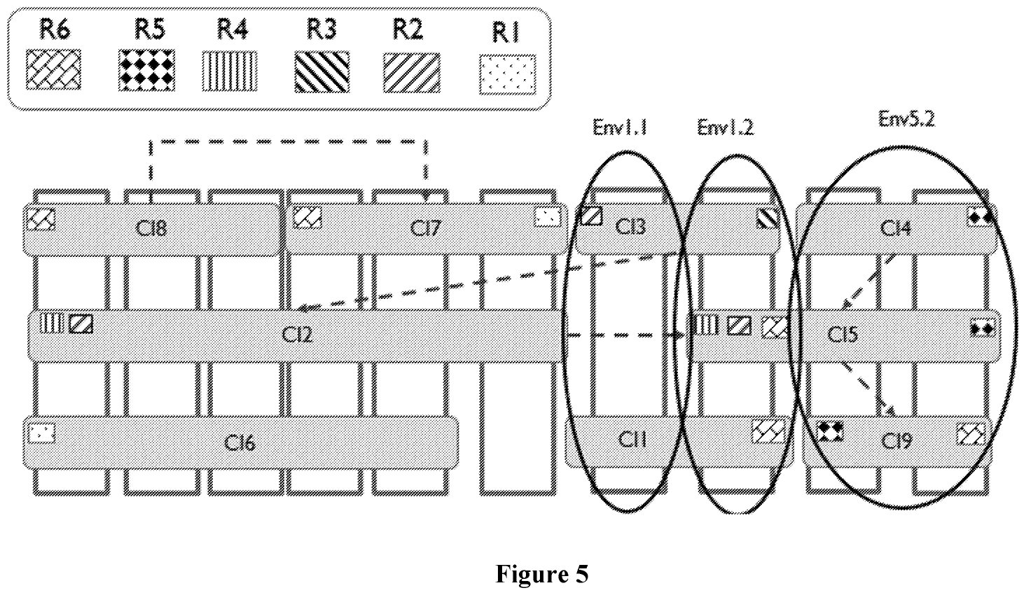

The system configuration taken as input for this example is shown in FIG. 5. The system is composed of nine CIs, each one of them handling a certain number of SIs shown as smaller squares inside the big rectangle (four for CI5, two for CI2, CI3, CI7 and CI9, one for the rest of the CIs). The squares of SIs that contribute to the realization of the same requirement are shown with the same pattern as the requirement they help to realize, i.e. squares R1-R6. Some CIs depend on other CIs and this is indicated by arrows (CI8 depends on CI7 for instance). From this configuration it is possible to identify the boundary environments to consider. The boundary environments related to CI1, for instance, are Env1.1 (which has a component of CI1 collocated with a component of CI3), and Env1.2 (which has a component of CI1 collocated with a component of CI3 and a component of CI5). CI3 has the same set of boundary environments as CI1. For CI5, in addition to Env1.2, it has also another boundary environment Env5.2 (which has a component of CI5 collocated with a component of CI4 and a component of CI9).

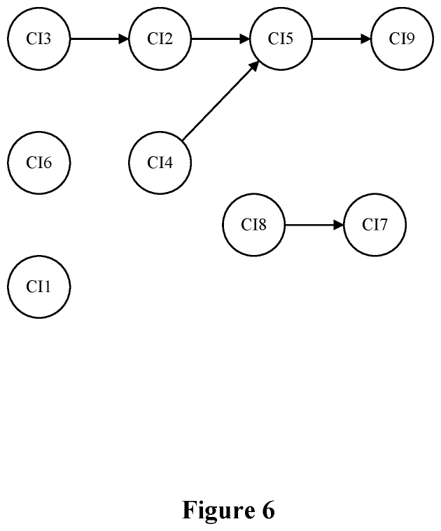

The CI call graph associated with this configuration is shown in FIG. 6. An edge between two CIs indicates that the source CI provides at least one SI that depends on at least one SI of the target CI. It is taken as input in the prototype as an instance of the CI call graph metamodel. This metamodel allows capturing the concepts needed for a weighted directed graph.

TABLE II
TSI CALL PATH MATRIX

| TSI | call paths |
|---|---|
| TC1 | {CI8 −> CI7, CI1} |
| TC2 | {CI3 −> CI2 −> CI5} |
| TC3 | {CI4 −> CI5 −> CI9} |
| TC4 | {CI2 −> CI5} |
| TC5 | {CI4, CI5} |

The TSI call path matrix is shown in Table II. Each TSI is associated with the set of SIs it traverses; from this information and the CI call graph, it is possible to deduce to which call path each TSI applies. Certain TSIs apply to a single call path such as TC2 which applies only to the path CI3->CI2->CI5. Other TSIs may apply to more than one path such as TC1, which applies to CI8->CI7 and CI1. Such differences may arise when some TSIs aim to validate the service of a specific tenant and which realize a certain requirement (the case of TC2), while others aim to validate the realizations of a specific requirement for more than one tenant (the case of TC1). As a result, indexes need to be appended to the TSI Ids to remove ambiguity (for instance TC1-0 is the application of TC1 to CI8->CI7 and TC1-1 is the application of TC1 to CI1).

In this small case study, a simple environment coverage case is considered. The coverage criterion is the same for all the TSIs and it is the “all boundary environment mixtures coverage”. Moreover, only mixtures of width one are considered. As a result, the set of test configurations generated for each TSI should involve each mixture of width one (i.e. boundary environment) of each CI along the call path at least once.

TABLE III
ISOLATION MATRIX (TIME UNIT: SECONDS)

| CI | Risk | Snapshot | Clone | Load relocation |
|---|---|---|---|---|
| CI1 | 1 | 0.3 | 1 | 0.001 |
| CI2 | 1 | 0.7 | 1.2 | 0.01 |
| CI3 | 0 | 0.4 | 1.3 | 0.03 |
| CI4 | 0 | 10 | 10 | 5 |
| CI5 | 1 | 5 | 5 | 3 |
| CI6 | 0 | 10 | 9 | 13 |
| CI7 | 1 | 4 | 5 | 3 |
| CI8 | 0 | 1 | 1 | 1 |
| CI9 | 1 | 0.1 | 0.1 | 0.1 |

Table III shows an example of the isolation matrix. In this matrix, for each CI it is noted in the first column whether the CI represents a risk of interferences (1 means there is a risk of interferences while 0 means there is no risk of interferences), and, in the rest of the columns respectively, the time needed for snapshotting, cloning, and relocating the service. This information along with the acceptable outage guides the choice of the test method for each CI.

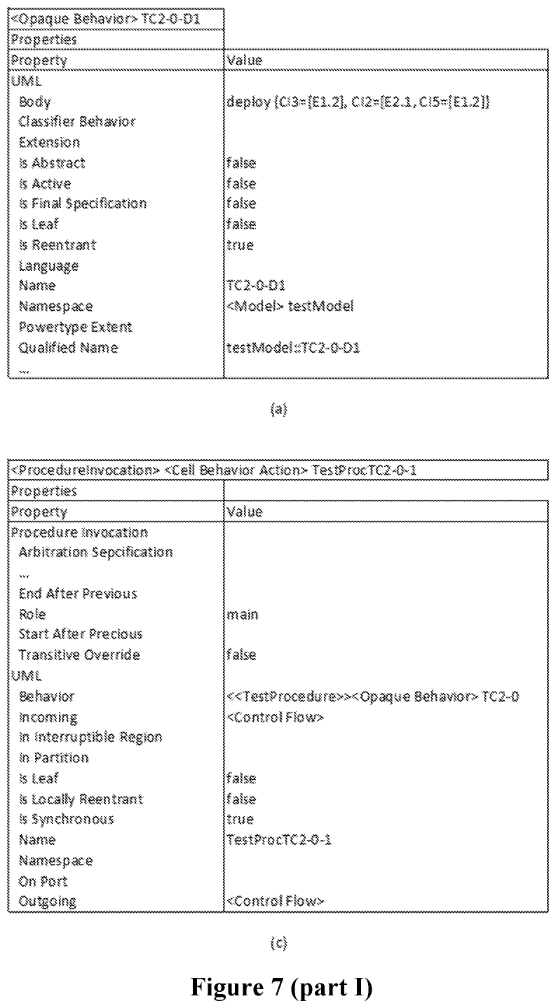

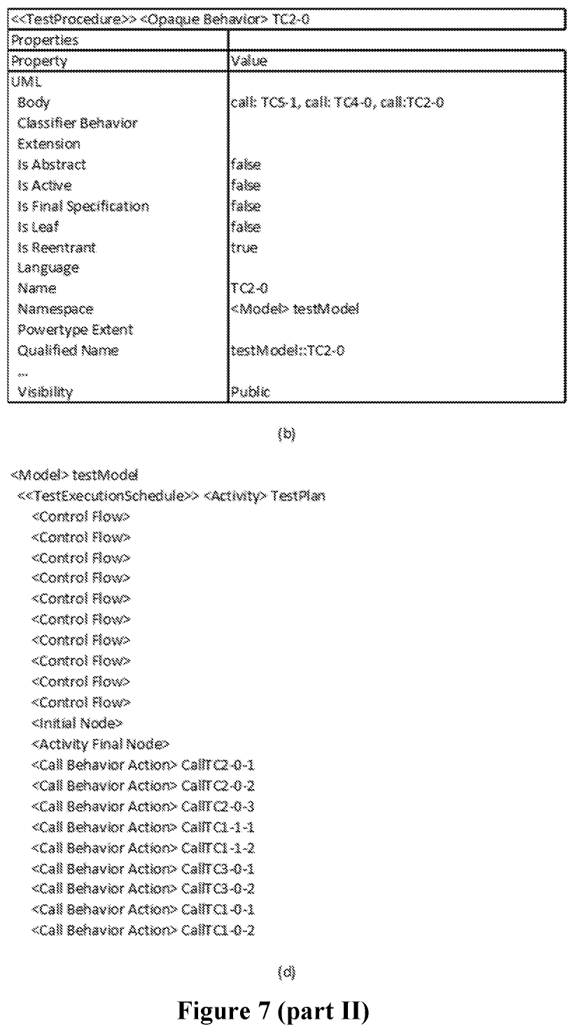

FIG. 7 shows the results of running the test plan generation prototype. The model elements that are first created in the model are the OpaqueBehavior model elements. These elements can be either for deploying or for removing test configurations (non-stereotyped OpaqueBehavior model elements); or, for invoking TSIs in which case they will be stereotyped with the UTP stereotype TestProcedure. Taking into consideration the test runs needed for the test session, UTP TestCase model elements are created (as Activity elements stereotyped with TestCase). Each TestCase model element invokes other model elements in the following order: first, an OpaqueBehavior as setup (to deploy the test configuration), then an OpaqueBehavior stereotyped as TestProcedure as its main procedure to invoke the TSIs; and, finally it invokes an OpaqueBehavior as teardown to remove the test configuration. After the creation of TestCases, an Activity stereotyped as TestExecutionSchedule is created, and it invokes the created TestCases taking into account all the ordering constraints to respect. FIG. 7 (a) shows an OpaqueBehavior used to deploy a test configuration, which can be seen in the Body attribute of the OpaqueBehavior, i.e. “deploy {CI3: {E3.1},CI2: {E2.1}, CI5: {E1.2}}”. The groups manifest at the level of OpaqueBehavior elements that are stereotyped by TestProcedure. FIG. 7 (b) shows a TestProcedure that invokes the grouped TSIs TC5-1, TC4-0, and TC2-0. Activities stereotyped as TestCase are then created as show in FIG. 7 (c) to capture the execution of a set of grouped TSIs under a specific test configuration. This grouping is done using CallBehaviorAction elements which invoke OpaqueBehaviors such as the ones shown in FIG. 7 (a) and FIG. 7 (b). Each invoked behavior has a role (setup, main, or teardown), taking into consideration that UTP only allows TestProcedures to be invoked as main. Finally, the TestCase elements are invoked within an Activity stereotyped TestExecutionSchedule as shown in FIG. 7 (d).

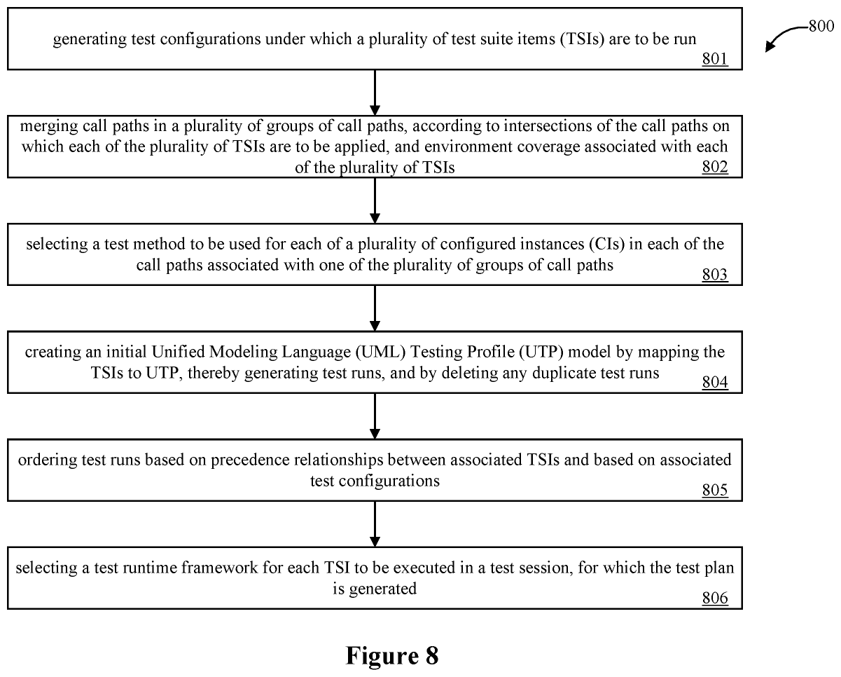

FIG. 8 illustrates a method 800 of test plan generation for live testing. Referring to FIGS. 4 and 8, the method comprises generating test configurations 401, 801 under which a plurality of test suite items (TSIs) are to be run. The method comprises merging call paths, step 402, 802, in a plurality of groups of call paths, according to intersections of the call paths on which each of the plurality of TSIs are to be applied, and environment coverage associated with each of the plurality of TSIs. The method comprises selecting, step 403, 803, a test method to be used for each of a plurality of configured instances (CIs) in each of the call paths associated with one of the plurality of groups of call paths. The method comprises creating, step 407, 804, an initial Unified Modeling Language (UML) Testing Profile (UTP) model by mapping the TSIs to UTP test cases, thereby generating test runs, and by deleting any duplicate test runs. The method comprises ordering, step 409, 805, test runs based on precedence relationships between associated TSIs and based on associated test configurations, to reduce disturbance. The method comprises selecting, step 411, 806, a test runtime framework for each TSI that is executed in a test session, for which the test plan is generated.

The test runtime framework can be defined as a set of libraries and tools needed to set up an environment in which the TSI can be executed.

The test runtime framework is selected primarily based on the TSI, using the TSI-test runtime framework matrix, as well as other input, and it is needed to be able to instantiate test components which are part of the tester, testing the components under test. E.g. test components may be sending the test traffic, receiving the response to the test traffic, evaluating the results, etc.

Component under test is different from the test component. The test component is instantiated at the execution of the TSI as part of the tester. The test runtime framework is needed to be able to instantiate and run such a test component. The test runtime framework is selected at the test plan generation by matching the TSI for which it is being selected with the TSI in the TSI-test runtime framework matrix.

The test configurations may be based on a system configuration and an environment coverage criterion provided as input for each TSI.

Merging call paths may take as input a test suite, 415, a TSI call path matrix, 417, an environment coverage-TSI matrix, 419, and a CIs call graph, 421.

Merging call paths may output a set of groups of TSIs, 439, and the test runs of TSIs of each group under a given test configuration may be invoked within a same UTP TestCase in a final UTP TestExecutionSchedule model.

A call path may be merged with a set of paths if the call path is a super-path to a max-path of the set of paths, and if a width of mixtures in which the call path is to be covered is greater than or equal to a maximum width in which the max-path of the set of paths is to be covered; or the call path may be a sub-path of the max-path of the set of paths, and there exists at least one mixture width in which the max-path of the set of paths is to be covered that is greater than or equal to the width of the mixtures in which the call path is to be covered.

The selecting a test method may take as input the groups of call paths, which include TSIs and associated paths, a system configuration, 413, a call graph of the CIs, 421, an isolation cost matrix, 423, a TSI execution time 425, and an acceptable outage, 431; and selecting the test method may take as input an availability of resources, a cost of isolation, dependencies between CIs, and an amount of tolerable disturbance for each SI.

The selecting a test method may comprise:
if only one test method is applicable, based on an applicability check, selecting the only one test method;
if more than one test method is applicable, selecting the test method based on a precedence, in order, from first to last: single step, big flip, small flip, and, rolling paths; and
if there is any conflict between two CIs, setting the test method as a preferred test method for the CI with a bigger number of mixtures.

A conflict can occur due to resources constraints as big and small flips need additional resources which might not be available for two CIs within a call path. E.g. not enough resources for using big flip for two CIs although it would be preferred for both CIs according to the second bullet. When selecting a test method, the entire call path to execute, which goes through potentially multiple CIs, is considered, therefore resources are needed for their testing at the same time and can get into conflict.

The ordering the test runs may take as input the test plan, with test runs in arbitrary order, and a test suite precedence matrix, 435.

The ordering the test runs may comprise using operators for: ordering test runs by changing an order of invocation of TSIs within a same UTP TestCase; ordering test runs by changing an order of UTP TestCases to order test runs based on test configurations involved in the test runs; and ordering test runs by changing the UTP TestCase within which a TSI is invoked.

The ordering the test runs may further comprise:
if a subset of UTP TestCases in which a leading TSI is invoked includes a subset of UTP TestCases in which a following TSI is invoked, then ordering invocations of the TSIs within the same UTP TestCase of the subset of UTP TestCases in which the following TSI is invoked in such a way that the following TSI is always invoked after the leading TSI;
if the subset of UTP TestCases in which the following TSI is invoked is a union of a subset of UTP TestCases in which the leading TSI is invoked and a subset of UTP TestCases in which the leading TSI is not invoked; then, for the first subset of the union, ordering the invocations of the TSIs within the same UTP TestCase in such a way that the following TSI is invoked after the leading TSI, and follow up with the second subset of the union in which the leading TSI is not invoked; and
else, ordering test runs by changing the UTP TestCase within which a TSI is invoked to move invocations of the following TSI to the first UTP TestCase in which it can be invoked, while maintaining a precedence constraint.

The ordering the test runs may further comprise:
for each call path, starting from a random UTP TestCase as the current UTP TestCase; and
selecting a next UTP TestCase as the one most similar to the current UTP TestCase; wherein if more than one UTP TestCases change the same number of mixtures of the test configuration as the current UTP TestCase, the TestCase that changes the less critical CIs is chosen.

The selecting the test runtime framework may take as input a test objective, 433, a test runtime framework deployment cost, 427, a TSI-test runtime framework matrix, 439, and a refined UTP model 443 obtained from the ordering.

The selecting the test runtime framework may further comprise adding a TestObjective to the UTP model, choosing a most suitable runtime framework deployment by identifying a runtime framework of the TSI from a TSI-test runtime framework matrix, 429, checking deployment options of the most suitable runtime framework and a test runtime framework deployment cost, 427, and choosing a least disturbing option. An order of deployment options from the least to the most disturbing is: container deployment, VM deployment and deployment using a configuration manager when no other option is available.

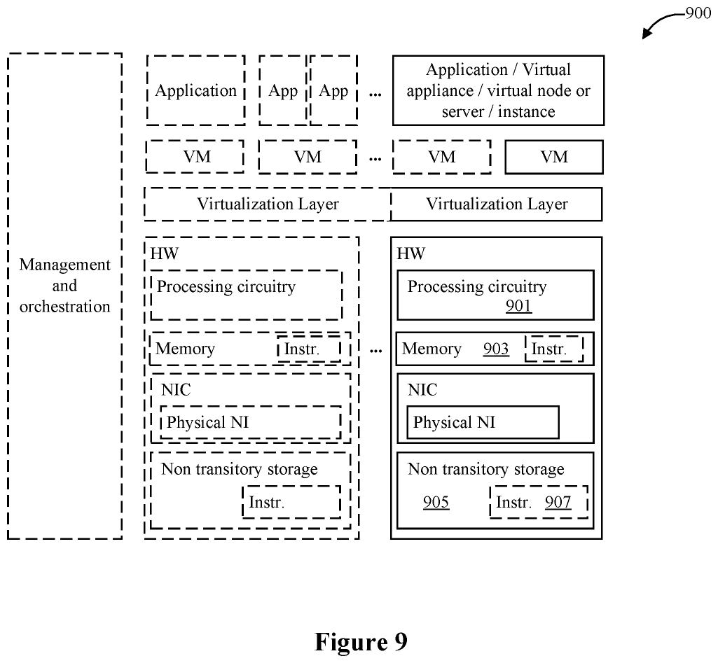

Referring to FIG. 9, there is provided a virtualization environment in which functions and steps described herein can be implemented.

A virtualization environment (which may go beyond what is illustrated in FIG. 9), may comprise systems, networks, servers, nodes, devices, etc., that are in communication with each other either through wire or wirelessly. Some or all of the functions and steps described herein may be implemented as one or more virtual components (e.g., via one or more applications, components, functions, virtual machines or containers, etc.) executing on one or more physical apparatus in one or more networks, systems, environment, etc.

A virtualization environment provides hardware comprising processing circuitry 901 and memory 903. The memory can contain instructions executable by the processing circuitry whereby functions and steps described herein may be executed to provide any of the relevant features and benefits disclosed herein.

The hardware may also include non-transitory, persistent, machine readable storage media 905 having stored therein software and/or instruction 907 executable by processing circuitry to execute functions and steps described herein.

The instructions 907 may include a computer program for configuring the processing circuitry 901. The computer program may be stored in a removable memory, such as a portable compact disc, portable digital video disc, or other removable media. The computer program may also be embodied in a carrier such as an electronic signal, optical signal, radio signal, or computer readable storage medium.

Still referring to FIG. 9, a system 900 or apparatus (HW) or node for test plan generation for live testing is provided. The system 900 or apparatus (HW) or node comprises processing circuits 901 and a memory 903, the memory containing instructions executable by the processing circuits 901 whereby the system 900 or apparatus (HW) or node is operative to execute any of the steps described herein. The system 900 is operative to generate test configurations under which a plurality of test suite items (TSIs) are to be run. The system is operative to merge call paths in a plurality of groups of call paths, according to intersections of the call paths on which each of the plurality of TSIs are to be applied, and environment coverage associated with each of the plurality of TSIs. The system is operative to select a test method to be used for each of a plurality of configured instances (CIs) in each of the call paths associated with one of the plurality of groups of call paths. The system is operative to create an initial Unified Modeling Language (UML) Testing Profile (UTP) model by mapping the TSIs to UTP test cases, thereby generating test runs, and deleting any duplicate test runs. The system is operative to order test runs based on precedence relationships between associated TSIs and based on associated test configurations. The system is operative to select a test runtime framework for each TSI, to be executed in a test session, for which the test plan is generated.

Referring to FIGS. 4 and 9, the test configurations may be based on a system configuration and an environment coverage criterion provided as input for each TSI. The call paths may be merged, taking as input a test suite, 415, a TSI call path matrix, 417, an environment coverage-TSI matrix, 419, and a CIs call graph, 421. The call paths merging may output a set of groups of TSIs, 439, and the test runs of TSIs of each group under a given test configuration may be invoked within a same UTP TestCase in a final UTP TestExecutionSchedule model.

A call path is merged with a set of paths if the call path is a super-path to a max-path of the set of paths, and if a width of mixtures in which the call path is to be covered is greater than or equal to a maximum width in which the max-path of the set of paths is to be covered; or the call path is a sub-path of the max-path of the set of paths, and there exists at least one mixture width in which the max-path of the set of paths is to be covered that is greater than or equal to the width of the mixtures in which the call path is to be covered. The test method selection may take as input the groups of call paths, which include TSIs and associated paths, a system configuration, 413, a call graph of the CIs, 421, an isolation cost matrix, 423, a TSI execution time 425, and an acceptable outage, 431; and the test method selection may take as input an availability of resources, a cost of isolation, dependencies between CIs, and an amount of tolerable disturbance for each SI.

The system may be further operative to select a test method according to: if only one test method is applicable, based on an applicability check, select the only one test method; if more than one test method is applicable, select the test method based on a precedence, in order from first to last: single step, big flip, small flip, and, rolling paths; and if there is any conflict between two CIs, set the test method as a preferred test method for the CI with a bigger number of mixtures.

The ordering of the test runs may take as input the test plan, with test runs in arbitrary order, and a test suite precedence matrix, 435. The system may be further operative to order the test runs using operators for ordering test runs by changing an order of invocation of TSIs within a same UTP TestCase; ordering test runs by changing an order of UTP TestCases to order test runs based on test configurations involved in the test runs; and ordering test runs by changing the UTP TestCase within which a TSI is invoked.

The system may be further operative to order the test runs according to: if a subset of UTP TestCases in which a leading TSI is invoked includes a subset of UTP TestCases in which a following TSI is invoked, then order invocations of the TSIs within the same UTP TestCase of the subset of UTP TestCases in which the following TSI is invoked in such a way that the following TSI is always invoked after the leading TSI; if the subset of UTP TestCases in which the following TSI is invoked is a union of a subset of UTP TestCases in which the leading TSI is invoked and a subset of UTP TestCases in which the leading TSI is not invoked; then, for the first subset of the union, order the invocations of the TSIs within the same UTP TestCase in such a way that the following TSI is invoked after the leading TSI, and follow up with the second subset of the union in which the leading TSI is not invoked; and else, order test runs by changing the UTP TestCase within which a TSI is invoked to move invocations of the following TSI to the first UTP TestCase in which it can be invoked, while maintaining a precedence constraint.

The system may be further operative to order the test runs further according to: for each call path, start from a random UTP TestCase as the current UTP TestCase; and select a next UTP TestCase as the one most similar to the current UTP TestCase; wherein if more than one UTP TestCases change the same number of mixtures of the test configuration as the current UTP TestCase, the TestCase that changes the less critical CIs is chosen.

The test runtime framework selection may take as input a test objective, 433, a test runtime framework deployment cost, 427, a TSI-test runtime framework matrix, 439, and a refined UTP model 443 obtained from the ordering.

The test runtime framework selection may further comprise to: add a TestObjective to the UTP model, choose a most suitable runtime framework deployment by identifying a runtime framework of the TSI from a TSI-test runtime framework matrix, 429, check deployment options of the most suitable runtime framework and a test runtime framework deployment cost, 427, and choose a least disturbing option. An order of precedence between the deployment options is, in order from first to last: container deployment, VM deployment, and deployment using a configuration manager when no other option is available.

The system may be a network node.

Still referring to FIG. 9, a non-transitory computer readable media 905 having stored thereon instructions 907 for test plan generation for live testing is provided. The instructions 907 comprise generating test configurations 401, 801 under which a plurality of test suite items (TSIs) are to be run. Referring to FIGS. 4 and 9, the instructions comprise merging call paths, step 402, 802, in a plurality of groups of call paths, according to intersections of the call paths on which each of the plurality of TSIs are to be applied, and environment coverage associated with each of the plurality of TSIs. The instructions comprise selecting, step 403, 803, a test method to be used for each of a plurality of configured instances (CIs) in each of the call paths associated with one of the plurality of groups of call paths. The instructions comprise creating, step 407, 804, an initial Unified Modeling Language (UML) Testing Profile (UTP) model by mapping the TSIs to UTP test cases, thereby generating test runs, and deleting any duplicate test runs. The instructions comprise ordering, step 409, 805, test runs based on precedence relationships between associated TSIs and based on associated test configurations. The instructions comprise selecting, step 411, 806, a test runtime framework for each TSI, to be executed in a test session, for which the test plan is generated.

The non-transitory computer readable media 905 may further comprise instructions for executing any of the steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method of test plan generation for live testing, comprising:
generating test configurations under which a plurality of test suite items (TSIs) are to be run;
merging call paths in a plurality of groups of call paths, according to intersections of the call paths on which each of the plurality of TSIs are to be applied, and environment coverage associated with each of the plurality of TSIs;
selecting a test method to be used for each of a plurality of configured instances (CIs) in each of the call paths associated with one of the plurality of groups of call paths;
creating an initial Unified Modeling Language (UML) Testing Profile (UTP) model by mapping the TSIs to UTP test cases, thereby generating test runs, and deleting any duplicate test runs;
ordering test runs based on precedence relationships between associated TSIs and based on associated test configurations; and
selecting a test runtime framework for each TSI, to be executed in a test session, for which the test plan is generated.

2. The method of claim 1, wherein the test configurations are based on a system configuration and an environment coverage criterion provided as input for each TSI.

3. The method of claim 1, wherein the step of merging call paths takes as input a test suite, a TSI call path matrix, an environment coverage-TSI matrix, and a CIs call graph.

4. The method of claim 3, wherein the step of merging call paths outputs a set of groups of TSIs and wherein the test runs of TSIs of each group under a given test configuration are invoked within a same UTP TestCase in a final UTP TestExecutionSchedule model.

5. The method of claim 4, wherein a call path is merged with a set of paths if the call path is a super-path to a max-path of the set of paths, and if a width of mixtures in which the call path is to be covered is greater than or equal to a maximum width in which the max-path of the set of paths is to be covered; or the call path is a sub-path of the max-path of the set of paths, and there exists at least one mixture width in which the max-path of the set of paths is to be covered that is greater than or equal to the width of the mixtures in which the call path is to be covered.

6. The method of claim 1, wherein the step of selecting a test method takes as input the groups of call paths, which include TSIs and associated paths, a system configuration, a call graph of the CIs, an isolation cost matrix, a TSI execution time and an acceptable outage; and wherein selecting the test method takes as input an availability of resources, a cost of isolation, dependencies between CIs, and an amount of tolerable disturbance for each SI.

7. The method of claim 1, wherein the step of selecting a test method comprises:
if only one test method is applicable, based on an applicability check, selecting the only one test method;
if more than one test method is applicable, selecting the test method based on a precedence, in order from first to last: single step, big flip, small flip, and, rolling paths; and
if there is any conflict between two CIs, setting the test method as a preferred test method for the CI with a bigger number of mixtures.

8. The method of claim 1, wherein the step of ordering the test runs takes as input the test plan, with test runs in arbitrary order, and a test suite precedence matrix.

9. The method of claim 1, wherein the step of ordering the test runs comprises using operators for:
ordering test runs by changing an order of invocation of TSIs within a same UTP TestCase;
ordering test runs by changing an order of UTP TestCases to order test runs based on test configurations involved in the test runs; and
ordering test runs by changing the UTP TestCase within which a TSI is invoked.

10. The method of claim 1, wherein the step of ordering the test runs further comprises:
if a subset of UTP TestCases in which a leading TSI is invoked includes a subset of UTP TestCases in which a following TSI is invoked, then ordering invocations of the TSIs within the same UTP TestCase of the subset of UTP TestCases in which the following TSI is invoked in such a way that the following TSI is always invoked after the leading TSI;
if the subset of UTP TestCases in which the following TSI is invoked is a union of a subset of UTP TestCases in which the leading TSI is invoked and a subset of UTP TestCases in which the leading TSI is not invoked; then, for the first subset of the union, ordering the invocations of the TSIs within the same UTP TestCase in such a way that the following TSI is invoked after the leading TSI, and follow up with the second subset of the union in which the leading TSI is not invoked; and
else, ordering test runs by changing the UTP TestCase within which a TSI is invoked to move invocations of the following TSI to the first UTP TestCase in which it can be invoked, while maintaining a precedence constraint.

11. The method of claim 1, wherein the step of ordering the test runs further comprises:
for each call path, starting from a random UTP TestCase as the current UTP TestCase; and
selecting a next UTP TestCase as the one most similar to the current UTP TestCase; wherein if more than one UTP TestCases change the same number of mixtures of the test configuration as the current UTP TestCase, the TestCase that changes the less critical CIs is chosen.

12. The method of claim 1, wherein selecting the test runtime framework takes as input a test objective, a test runtime framework deployment cost, a TSI-test runtime framework matrix, and a refined UTP model obtained from the ordering.

13. The method of claim 1, wherein the step of selecting the test runtime framework further comprises adding a TestObjective to the UTP model, choosing a most suitable runtime framework deployment by identifying a runtime framework of the TSI from a TSI-test runtime framework matrix, checking deployment options of the most suitable runtime framework and a test runtime framework deployment cost, and choosing a least disturbing option; wherein an order of precedence between the deployment options is, in order from first to last: container deployment, VM deployment, and deployment using a configuration manager when no other option is available.

14. A system for test plan generation for live testing comprising processing circuits and a memory, the memory containing instructions executable by the processing circuits whereby the system is operative to:
generate test configurations under which a plurality of test suite items (TSIs) are to be run;
merge call paths in a plurality of groups of call paths, according to intersections of the call paths on which each of the plurality of TSIs are to be applied, and environment coverage associated with each of the plurality of TSIs;
select a test method to be used for each of a plurality of configured instances (CIs) in each of the call paths associated with one of the plurality of groups of call paths;
create an initial Unified Modeling Language (UML) Testing Profile (UTP) model by mapping the TSIs to UTP test cases, thereby generating test runs, and deleting any duplicate test runs;
order test runs based on precedence relationships between associated TSIs and based on associated test configurations; and
select a test runtime framework for each TSI, to be executed in a test session, for which the test plan is generated.

15. The system of claim 14, wherein the test configurations are based on a system configuration and an environment coverage criterion provided as input for each TSI.

16. The system of claim 14, wherein call paths are merged, taking as input a test suite, a TSI call path matrix, an environment coverage-TSI matrix, and a CIs call graph.

17. The system of claim 16, wherein call paths merging outputs a set of groups of TSIs, and wherein the test runs of TSIs of each group under a given test configuration are invoked within a same UTP TestCase in a final UTP TestExecutionSchedule model.

18. The system of claim 17, wherein a call path is merged with a set of paths if the call path is a super-path to a max-path of the set of paths, and if a width of mixtures in which the call path is to be covered is greater than or equal to a maximum width in which the max-path of the set of paths is to be covered; or the call path is a sub-path of the max-path of the set of paths, and there exists at least one mixture width in which the max-path of the set of paths is to be covered that is greater than or equal to the width of the mixtures in which the call path is to be covered.

19. The system of claim 14, wherein the test method selection takes as input the groups of call paths, which include TSIs and associated paths, a system configuration, a call graph of the CIs, an isolation cost matrix, a TSI execution time, and an acceptable outage; and wherein the test method selection takes as input an availability of resources, a cost of isolation, dependencies between CIs, and an amount of tolerable disturbance for each SI.

20. The system of claim 14, further operative to select a test method according to:
if only one test method is applicable, based on an applicability check, select the only one test method;
if more than one test method is applicable, select the test method based on a precedence, in order from first to last: single step, big flip, small flip, and, rolling paths; and
if there is any conflict between two CIs, set the test method as a preferred test method for the CI with a bigger number of mixtures.

21. The system of claim 14, wherein the ordering of the test runs takes as input the test plan, with test runs in arbitrary order, and a test suite precedence matrix, 435.

22. The system of claim 14, further operative to order the test runs using operators for:
ordering test runs by changing an order of invocation of TSIs within a same UTP TestCase;
ordering test runs by changing an order of UTP TestCases to order test runs based on test configurations involved in the test runs; and
ordering test runs by changing the UTP TestCase within which a TSI is invoked.

23. The system of claim 14, further operative to order the test runs according to:
if a subset of UTP TestCases in which a leading TSI is invoked includes a subset of UTP TestCases in which a following TSI is invoked, then order invocations of the TSIs within the same UTP TestCase of the subset of UTP TestCases in which the following TSI is invoked in such a way that the following TSI is always invoked after the leading TSI;
if the subset of UTP TestCases in which the following TSI is invoked is a union of a subset of UTP TestCases in which the leading TSI is invoked and a subset of UTP TestCases in which the leading TSI is not invoked; then, for the first subset of the union, order the invocations of the TSIs within the same UTP TestCase in such a way that the following TSI is invoked after the leading TSI, and follow up with the second subset of the union in which the leading TSI is not invoked; and
else, order test runs by changing the UTP TestCase within which a TSI is invoked to move invocations of the following TSI to the first UTP TestCase in which it can be invoked, while maintaining a precedence constraint.

24. The system of claim 14, further operative to order the test runs according to:
for each call path, start from a random UTP TestCase as the current UTP TestCase; and
select a next UTP TestCase as the one most similar to the current UTP TestCase; wherein if more than one UTP TestCases change the same number of mixtures of the test configuration as the current UTP TestCase, the TestCase that changes the less critical CIs is chosen.

25. The system of claim 14, wherein the test runtime framework selection takes as input a test objective, a test runtime framework deployment cost, a TSI-test runtime framework matrix, and a refined UTP model obtained from the ordering.

26. The system of claim 14, wherein the the test runtime framework selection further comprises to: add a TestObjective to the UTP model, choose a most suitable runtime framework deployment by identifying a runtime framework of the TSI from a TSI-test runtime framework matrix, check deployment options of the most suitable runtime framework and a test runtime framework deployment cost, and choose a least disturbing option; wherein an order of precedence between the deployment options is, in order from first to last: container deployment, VM deployment, and deployment using a configuration manager when no other option is available.

27. The system of claim 14, wherein the system is a network node.

28. A non-transitory computer readable media having stored thereon instructions for test plan generation for live testing, the instructions comprising:
generating test configurations under which a plurality of test suite items (TSIs) are to be run;
merging call paths in a plurality of groups of call paths, according to intersections of the call paths on which each of the plurality of TSIs are to be applied, and environment coverage associated with each of the plurality of TSIs;
selecting a test method to be used for each of a plurality of configured instances (CIs) in each of the call paths associated with one of the plurality of groups of call paths;
creating an initial Unified Modeling Language (UML) Testing Profile (UTP) model by mapping the TSIs to UTP test cases, thereby generating test runs, and deleting any duplicate test runs;
ordering test runs based on precedence relationships between associated TSIs and based on associated test configurations; and
selecting a test runtime framework for each TSI, to be executed in a test session, for which the test plan is generated.

29. (canceled)
